(19) United States
(12) Patent Application Publication
(10) Pub. No.: US 2012/0318121 A1
(43) Pub. Date: Dec. 20, 2012

(54) TABLET COMPUTER GUITAR CONTROLER

(75) Inventors: Wendy L. Mittelstadt, Lowell, MA (US); Christopher B. Roman, Wrentham, MA (US); Brian R. Shim, Providence, RI (US)

(73) Assignee: ION AUDIO, LLC, Cumberland, RI (US)

(21) Appl. No.: 13/463,052

(22) Filed: May 3, 2012

Related U.S. Application Data
(60) Provisional application No. 61/497,493, filed on Jun. 15, 2011.
(60) Provisional application No. 61/587,462, filed on Jan. 17, 2012.

(51) Int. Cl. G10H 3/00

(52) U.S. Cl. 84/743

(57) ABSTRACT

A guitar controller for a tablet computer is disclosed. The guitar controller includes a body having a cavity formed therein sized and dimensioned to receive a tablet computer. The body has an edge on a front of the body defining an opening into the cavity. The edge has a thickness forming a lip into the opening wherein the lip is configured and arranged to be received partially over the tablet computer. A neck extends from the body and has a plurality of simulated fret positions thereon. An electronic circuit is included and configured and arranged to transmit a message encoded with presses of the simulated fret positions to the tablet computer.

### CROSS-REFERENCE TO RELATED APPLICATIONS

This patent document claims priority to earlier filed U.S. Ser. No. 61/497,493, filed on Jun. 15, 2011, and U.S. Ser. No. 61/587,462, filed on Jan. 17, 2012, the entire contents of which are incorporated herein by reference.

### BACKGROUND

1. Technical Field

The present patent document relates generally to electronic music instruments and more particularly to a guitar controller for a tablet computer with a touch control interface, such as an iPad® brand tablet computer.

2. Background of the Related Art

Tablet computers, such as the Apple iPad brand tablet computer, have emerged as popular devices for creating and composing music. Although a tablet computer's touch screen offers some interesting possibilities for the control and creation of music, these touch screens are inherently small when compared to the control surface of a guitar or piano. Also, the touch interface requires users to learn a new way of playing and composing music. That is, the touch control interface does not permit a user to interact with a full size piano keyboard or simultaneously strum and operate the frets of a simulated guitar in the same manner as operating the respective music instrument.

Therefore, there is a perceived need in the industry for an interface for a tablet computer that permits a user to compose and play music as one would with a traditional instrument.

### SUMMARY

The present invention solves the problems of the prior art by providing a controller for a tablet computer that permits a musician to create music in a way that is familiar to guitar players, yet offers new possibilities for music creation, in a cost-effective manner. In addition, the controller can teach the fundamentals of guitar chords and playing to budding musicians.

The controller uses the tablet computer's touch screen and digital signal processing (“DSP”) engine to control and produce the sound. Use of the tablet computer's inherent components reduces the cost of the controller because these components do not need to be included in the controller.

The controller includes a guitar-style neck so that the control of the pitch values will be familiar to guitar players. Other controls can be added such as whammy bar to bend pitch, just like in a traditional electric guitar, and knobs to control volume and audio effects like distortion.

### BRIEF DESCRIPTION OF THE DRAWINGS

These and other features, aspects, and advantages of the present invention will become better understood with reference to the following description, appended claims, and accompanying drawings where:

FIG. 1 is a sketch of a first embodiment of the controller showing a simulated guitar having neck with number of fret buttons to simulate chords and notes;

FIG. 2 is a sketch of a second embodiment of the controller showing a simulated guitar having a neck with a number of touch sensitive strips simulating frets on the guitar;

FIG. 3 is a sketch of a third embodiment of the controller showing a tablet computer that may be front-loaded into the guitar body;

FIG. 4 is a diagram of the an embodiment of the electrical operation of the controller using low speed serial communications with the tablet computer and also showing two distinct methods of audio output;

FIG. 5 is a diagram of the alternative embodiment of the electrical operation of the controller using a high-speed data port with the tablet computer and showing two distinct methods of audio output;

FIG. 6 is a diagram of yet a third alternative embodiment of the electrical operation of the controller using wireless communication with the tablet computer;

FIG. 7 is a front perspective view of a fourth embodiment of the controller;

FIG. 8 is a top perspective view of a fourth embodiment of the controller;

FIG. 9 is a rear perspective view of the body of the controller showing the door mechanism;

FIG. 10 is a front perspective view of the body of the controller showing the depth of the tablet computer in the body;

FIG. 11 is a front perspective view of a fifth embodiment of the controller;

FIG. 12 is a front perspective view of the fifth embodiment with the tablet computer removed from the body of the controller;

FIG. 13 is a rear perspective view of the fifth embodiment of the controller;

FIG. 14 is a cross-section view through line 14-14 of FIG. 11;

FIG. 15 is a cross-section view through line 15-15 of FIG. 13;

FIG. 16 is a front perspective view of an insert for adapting a handheld computing device for use in the controller; and

FIG. 17 is a rear perspective view of an insert for adapting a handheld computing device for use in the controller.

### DESCRIPTION OF THE PREFERRED EMBODIMENT

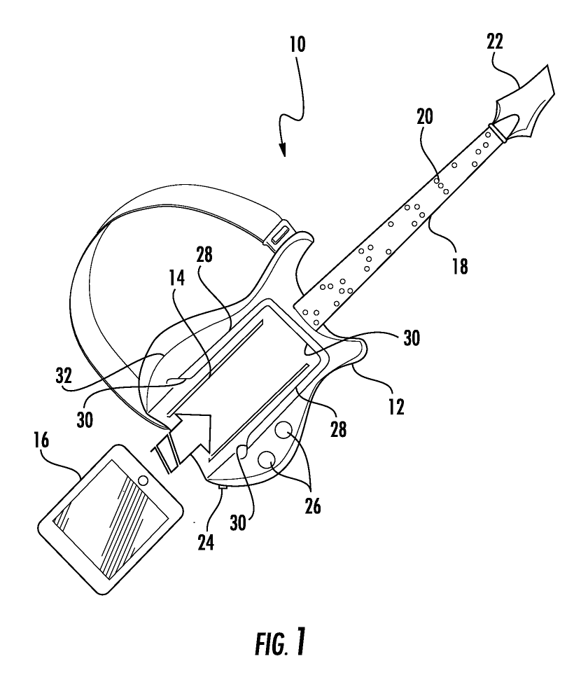

Referring now to FIG. 1, a first embodiment of the controller is generally shown at 10. The controller 10 includes a simulated guitar body 12, in which there is a cavity 14 to capture and hold a tablet computer 16, such as an Apple iPad brand tablet computer, while the controller 10 is being played. A connector or cable is included that connects to the tablet computer 16. In the case of an iPad brand tablet computer, the iPad's 30-pin bottom connector is used. Extending from the guitar body 12 is a guitar neck 18 with a number of note buttons 20 located at simulated fret positions. A head 22 may extend from the guitar neck 18.

The note buttons 20 may include lights, such as LEDs, which may be lit individually and in sequence. When lit sequentially, the user can be taught how to play the guitar or how to play a particular song. The lights within the note buttons 20 may also light when the note buttons 20 are pressed by the user in a playing mode.

The body 12 has an edge 28 on a front 32 of the body 12 defining an opening into the cavity 14. The edge 28 forms a lip 30 into the opening wherein the lip 30 is received partially over the tablet computer 16.

In addition, there can be an audio output 24 on the guitar body 12. Preferably, this audio output is in the form of a ¼″ mono or stereo female connector. The audio output 24 is connected to the tablet computer 16 audio output. In the case of an iPad brand tablet computer, the audio output is on the iPad's 30-pin connector.

The guitar body 12 may include one or more knobs 26 to control volume, tone, or other audio effects.

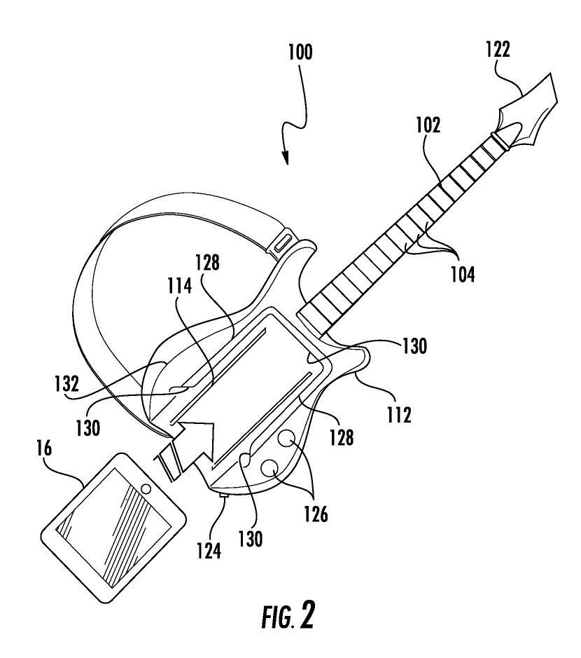

Referring now to FIG. 2, a second embodiment of the controller is shown generally at 100. In addition to the features described above for the first embodiment 10, the second embodiment 100 includes a guitar neck 102 extending from the guitar body 112. The guitar neck 102 includes a plurality of touch strip controllers 104 that simulate frets and finger position on the neck 102 of the guitar body 112 instead of using note buttons 20. The guitar neck 102 may include a head 122 opposite the body 112. The guitar body 112 may also, likewise, include an audio output 124 and one or more knobs 126 to control volume, tone, or other audio effects. The body 112 includes a cavity 114 sized and dimensioned to receive a tablet computer 16 therein.

The touch strip controllers 104 may include lights, such as LEDs, which may be lit individually and in sequence. When lit sequentially, the user can be taught how to play the guitar or how to play a particular song. The lights within the touch strip controllers 104 may also light when the touch strip controllers 104 are pressed by the user in a playing mode.

The body 112 has an edge 128 on a front 132 of the body 112 defining an opening into the cavity 114. The edge 128 forms a lip 130 into the opening wherein the lip 130 is received partially over the tablet computer 16.

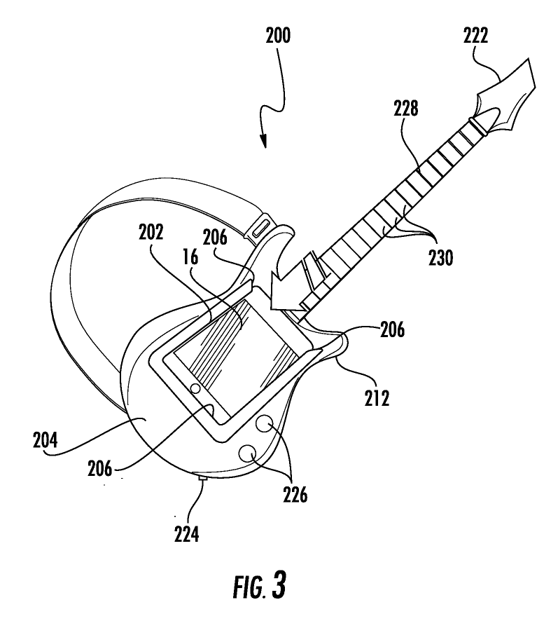

As can be seen in FIG. 3, a third embodiment 200 shows that the opening on the cavity (occupied by the tablet computer 16) of the guitar body 212 may be oriented in another direction to receive the tablet computer 16. Although the cavity 214 shown in FIGS. 1 and 2 shows a rear-loading cavity, and FIG. 3 shows a front-loading cavity, one skilled in the art would appreciate that the cavity may be configured to receive the tablet computer 16 in some other direction as may be directed by the shape of the guitar body 212 and desired features of the controller 10,100, 200. The body 212 has an edge 202 on a front 204 of the body 212 defining an opening into the cavity. The edge 202 forms a lip 206 into the opening wherein the lip 206 is received partially over the tablet computer 16.

The guitar body 212 may also, likewise, include an audio output 224 and one or more knobs 226 to control volume, tone, or other audio effects. The guitar body may also include a neck 228, which may include a head 222 opposite the body 212 like the other embodiments 10, 100. The neck 226 includes a plurality of simulated fret positions 230, which may be note buttons or touch strip controllers, like the other embodiments 10, 100.

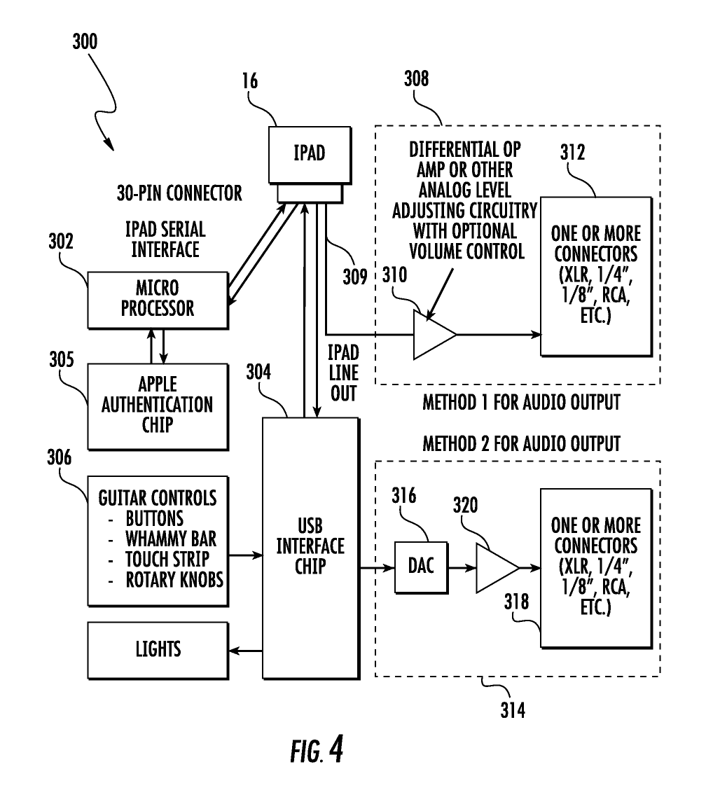

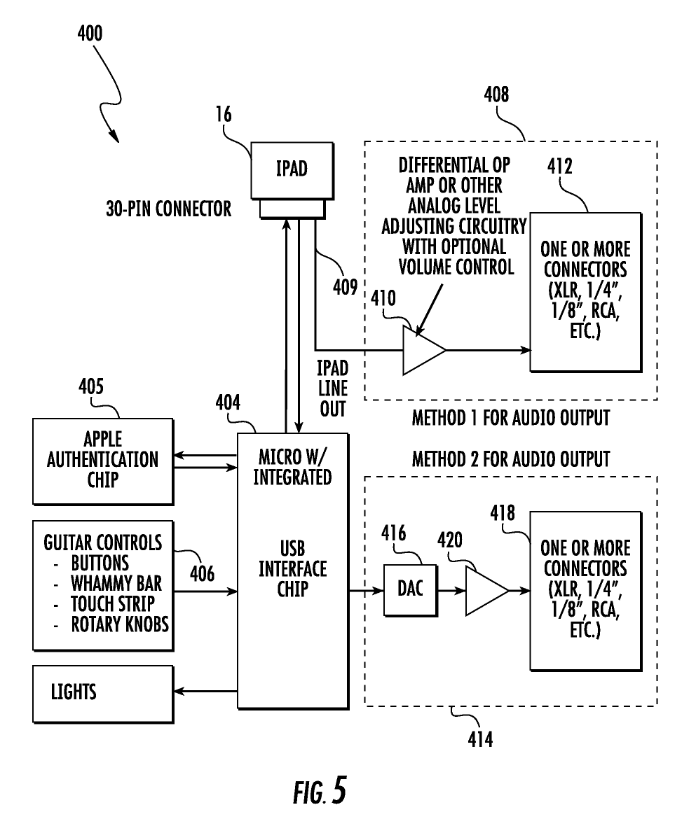

Three embodiments of implementing the electronic circuit for the various embodiments of the controller are shown generally in FIGS. 4-6. In the first method 300, shown in FIG. 4, a microprocessor 302 authenticates the tablet computer 16, such as the iPad brand tablet computer, through dedicated low-speed serial communication pins on the iPad's 30-pin connector via an authentication chip 305. The second method 400, shown in FIG. 5, to implement the electrical operation of the controller is to communicate with the tablet computer 16 solely through a high-speed data controller 404, such as a universal serial bus controller. In a third method 500, shown in FIG. 6, the electrical operation of the controller uses wireless communication with the tablet computer 16.

Turning first to FIG. 4, a high-speed data serial controller 304, such as a universal serial bus controller, reads the state of the various guitar controls 306, i.e. finger position on the buttons and/or touch sensitive frets controls, whammy bar, and knobs. The state of the controls is read by the controller 304 and converted into messages (such as Core MIDI messages) sent to the tablet computer 16 to trigger actions such as determining pitch of the note being played, applying audio effects like distortion, or bending pitch. Software running on the tablet computer 16 receives the messages and plays a sound out the audio output of the tablet computer 16 in response to the messages received. Audio output of the tablet computer 16 may be transmitted digitally via the high-speed data controller 304 or out a standard analog line output equipped on most tablet computers 16.

In addition, the controller 304 may receive messages from the software running on the tablet computer 16 to active and deactivate selected lights in the simulated fret positions of the touch strip controllers or note buttons.

In this embodiment, there are two methods for outputting audio from the tablet computer 16. The first 308 is through the analog line output 309 included on the tablet computer 16 itself, marked as “Method 1” in FIG. 4. The analog line output 309 is passed through a differential operational amplifier 310, which may include an optional volume control. The differential operational amplifier 308 is connected to one or more connectors 312, such as XLR jacks, ¼″ jack, ⅛″ jack, RCA jacks, or other audio connectors.

The second method 314 for outputting audio from the tablet computer 16, marked “Method 2” is digitally through the high-speed data controller 304. Digital audio transmitted via the high-speed data controller 304 is passed through a digital-to-analog converter 316. The digital-to-analog converter 316 is connected to one or more connectors 318, such as XLR jacks, ¼″ jack, ⅛″ jack, RCA jacks, or other audio connectors. The analog output of the digital-to-analog converter 316 may also be passed through a differential operational amplifier 320, which may include an optional volume control, prior to being passed transmitted to the connectors 318. Although both methods 308, 314 are shown in FIG. 4, in practice only one would be used.

Turning now to FIG. 5, a second method 400 to implement the controller is to communicate with the tablet computer 16 solely through the high-speed data controller 404 that is integrated with a microprocessor. A microprocessor with high-speed data controller 404 communicates with and authenticates the tablet computer 16 to enable features through an authentication chip 405, if needed. The microprocessor also reads the state of the guitar controls 406 and converts them to messages (such as Core MIDI format) that are transmitted to the tablet computer 16 to trigger actions such as determining pitch of the note being played, applying audio effects like distortion, or bending pitch. Software running on the tablet computer 16 receives the messages and plays a sound out the audio output of the tablet computer 16 in response to the messages received. Audio output of the tablet computer 16 may be transmitted digitally via the high-speed data controller 404 or out a standard analog line output 409 equipped on most tablet computers 16.

In addition, the integrated microprocessor and high-speed data controller 404 may receive messages from the tablet computer 16 to activate and deactivate selected lights in the simulated fret positions of the touch strip controllers or note buttons.

In this embodiment 400, there are two methods for outputting audio from the tablet computer 16. The first 408 is through the analog outputs 409 included on the tablet computer 26, marked as “Method 1” in FIG. 5. The analog line output 409 is passed through a differential operational amplifier 410, which may include an optional volume control. The differential operational amplifier 410 is connected to one or more connectors 412, such as XLR jacks, ¼″ jack, ⅛″ jack, RCA jacks, or other audio connectors.

The second method 414 for outputting audio from the tablet computer 16, marked “Method 2” is digitally through the high-speed data controller 404. Digital audio transmitted via the high-speed data controller 404 is passed through a digital-to-analog converter 416. The digital-to-analog converter 416 is connected to one or more connectors 418, such as XLR jacks, ¼″ jack, ⅛″ jack, RCA jacks, or other audio connectors. The analog output of the digital-to-analog converter 416 may also be passed through a differential operational amplifier 420, which may include an optional volume control, prior to being passed transmitted to the connectors 418.

Although both methods 408, 414 are shown in FIG. 5, in practice only one would be used.

Turning now to FIG. 6, a third method 500 to implement the electrical operation of the controller 10, 100 is to use a wireless communication protocol, such as a Bluetooth connection. In this embodiment, the guitar controls 502 are mapped to standard Bluetooth HID commands such as QWERTY keyboard commands. The tablet computer 16 receives the commands and, using a customized software application, would interpret these commands as control signals for the controller instead of letters on a keyboard. For example, the letter “A” could be sent when the first fret is depressed and so on.

One way to accomplish this would be to use a standard Bluetooth HID module such 504 as the Blue Packet BP20422 Bluetooth HID module. Other modules may be used and other wireless protocols may be used as well.

Audio may also be received from the tablet computer 16 via a wireless audio module 506 implementing a wireless communication protocol, such as Bluetooth connection. The wireless audio module 506 receives the audio from the tablet computer 16 and transmits digital audio to a digital-to-analog converter 508. The digital-to-analog converter 508 is connected to one or more connectors 510, such as XLR jacks, ¼″ jack, ⅛″ jack, RCA jacks, or other audio connectors. The analog output of the digital-to-analog converter 508 may also be passed through a differential operational amplifier 512, which may include an optional volume control, prior to being passed transmitted to the connectors 510.

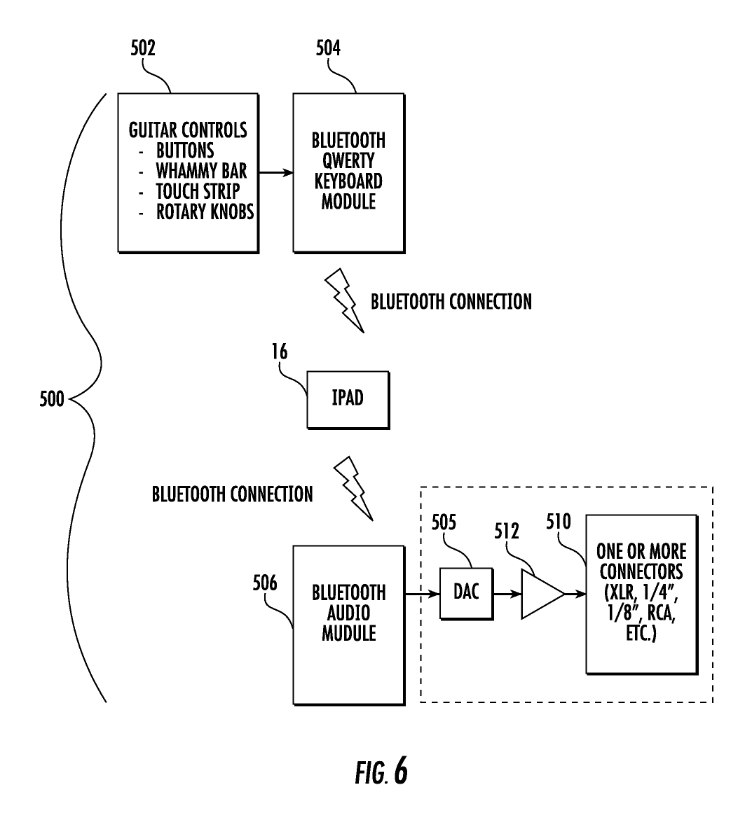

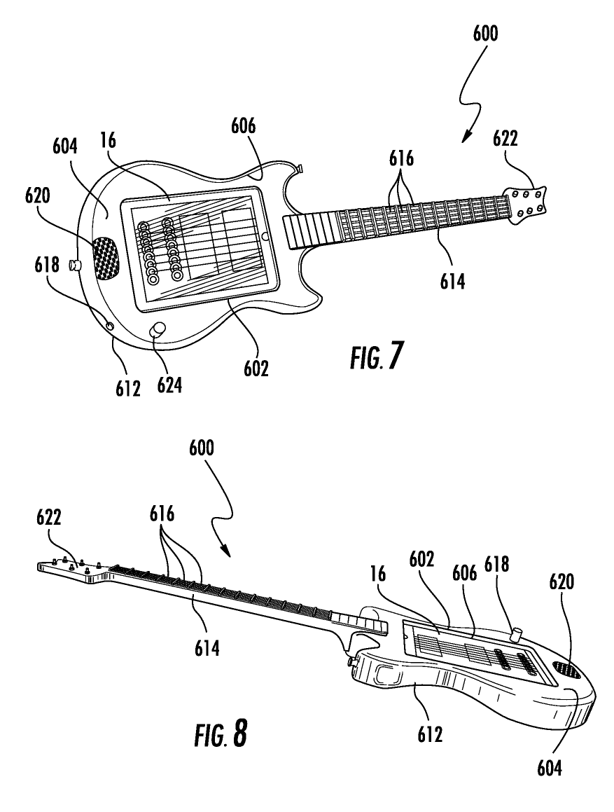

Referring now to FIGS. 7 and 8, a fourth embodiment of the controller is shown generally at 600. The controller 600 includes a simulated guitar body 612, in which there is a cavity to capture and hold a tablet computer 16, such as an Apple iPad brand tablet computer, while the controller 600 is being played. The body 612 has an edge 602 on a front 604 of the body 612 defining an opening into the cavity. The edge 602 has a thickness forming a lip 606 into the opening wherein the lip 606 is received partially over the tablet computer 16.

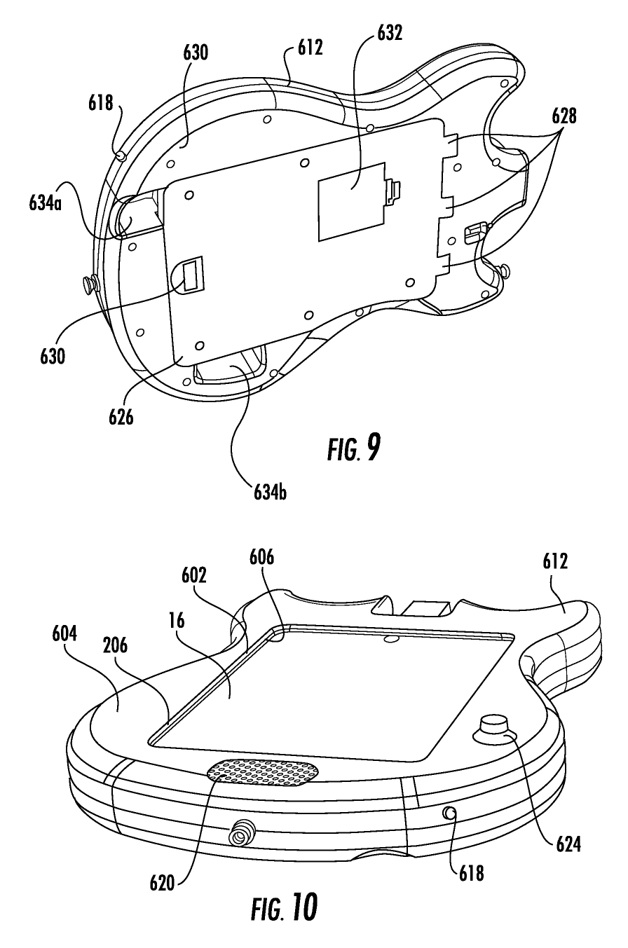

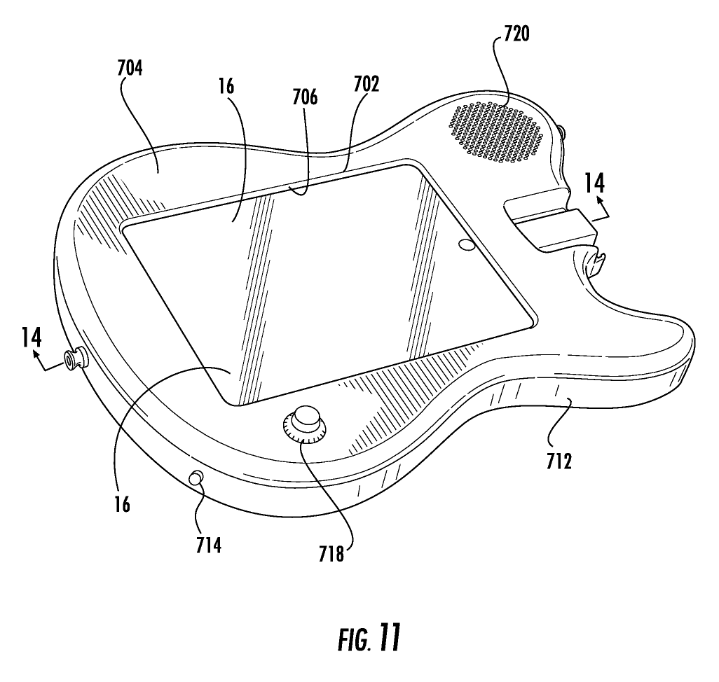

The tablet computer 16 may interface with the controller 600 with a connector or cable or wirelessly as described above with the other embodiments 200, 300, 400. Extending from the guitar body 612 is a guitar neck 614 with a number of note buttons 616 located at simulated fret positions. (As shown in FIGS. 9 and 10 the neck 614 may detach from the body 612). The electronic circuit for communicating note button 616 presses may be located in the guitar neck 616. A head 622 may extend from the guitar neck 614.

The note buttons 616 include lights, such as LEDs, which may be lit individually and in sequence. When lit sequentially, the user can be taught how to play the guitar or how to play a particular song. The lights within the note buttons 616 may also light when the note buttons 616 are pressed by the user in a playing mode.

In addition, there can be an audio output 618 on the guitar body 612. Preferably, this audio output 618 is in the form of a ¼″ mono or stereo female connector. The audio output 618 is connected to the tablet computer 16 audio output. In the case of an iPad brand tablet computer, the audio output is on the iPad's 30-pin connector. Optionally, the audio output may be routed to a built-in speaker 620, which may include its own volume control.

The guitar body 612 may include one or more knobs 624 to control volume, tone, or other audio effects.

Referring to FIG. 9, the tablet computer 16 is secured within the guitar body 612 by a door 626. The door 626 is hinged by one or more hinges 628 to the rear 630 of the guitar body 612. Although three hinges 628 are depicted, fewer or more hinges 628 may be added as is known in the art. A locking mechanism 630 secures the door 626 shut against the body 612. Batteries powering the electrical circuit 200, 300, 400 may be housed in a battery compartment 632 contained in the door 626.

Recesses 634a, 634b are provided on the rear 630 of the guitar body 612 to allow access to the headphone output and to manipulate buttons on the tablet computer 16, respectively, such as power, rotation lock, volume and mute switches.

Referring to FIG. 10, the tablet computer 16 is recessed inside the body 612 of the controller 600, thereby providing the musician tactile feedback when they have strayed off of the touch screen of the tablet computer 16. As shown, the tablet computer 16 is recessed 4.5 mm within the guitar body, but other depths may be used. Tablet computers 16 that are mounted within a guitar body 612 in a generally flush manner suffer the limitation that the musician may lose track of where they are on the tablet computer 16 touch screen.

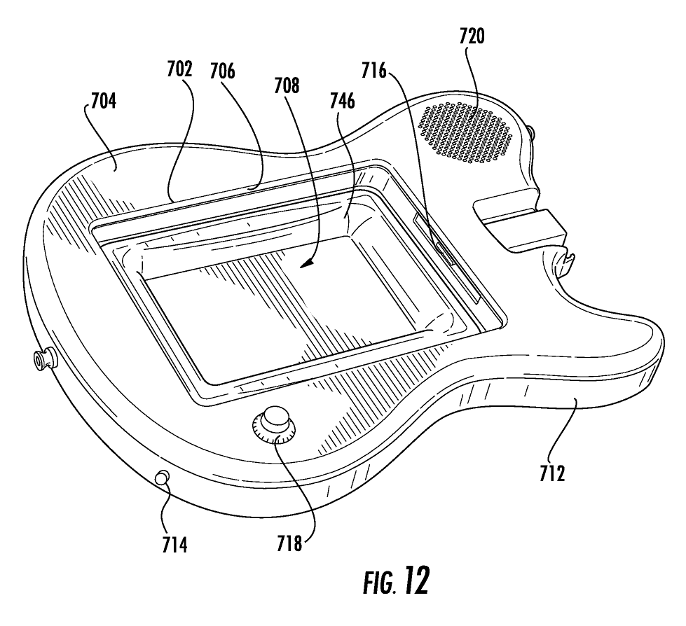

Referring now to FIGS. 11 and 12, a fifth embodiment of the controller is shown generally at 700. The controller 700 includes a simulated guitar body 712, in which there is a cavity 708 to capture and hold a tablet computer 16, such as an Apple iPad brand tablet computer, while the controller 700 is being played. The body 712 has an edge 702 on a front 704 of the body 712 defining an opening into the cavity 708. The edge 702 has a thickness forming a lip 704 into the opening wherein the lip 704 is received partially over the tablet computer 16.

The tablet computer 16 may interface with the controller 700 with a connector 716 or cable or wirelessly as described above with the other embodiments 200, 300, 400. Although not shown here, the controller 700 may have, extending from the guitar body 712, a guitar neck with a number of note buttons or touch strip controllers located at simulated fret positions like the other embodiments shown 10, 100, 200, 600. A head may extend from the guitar neck as well. The electronic circuit 300, 400, 500 for communicating note button or touch strip controller presses may be located in the guitar neck in order to reduce manufacturing cost.

In addition, there can be an audio output 714 on the guitar body 712. Preferably, this audio output 714 is in the form of a ¼″ mono or stereo female connector. The audio output 714 is connected to the tablet computer 16 audio output. In the case of an iPad brand tablet computer, the audio output is on the iPad's 30-pin connector. Optionally, the audio output may be routed to a built-in speaker 720, which may include its own volume control.

The guitar body 712 may include one or more knobs 718 to control volume, tone, or other audio effects.

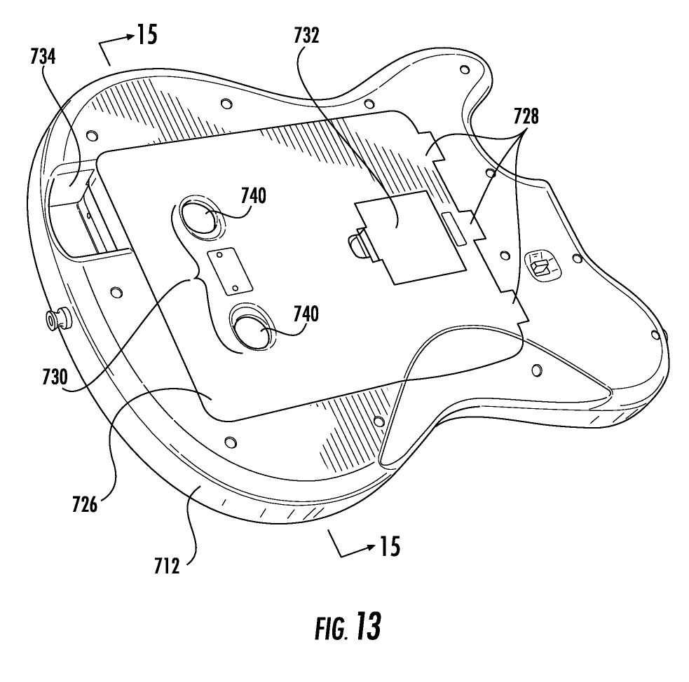

Referring to FIG. 13, the tablet computer 16 is secured within the guitar body 712 by a door 726. The door 726 is hinged by one or more hinges 728 to the rear 730 of the guitar body 712. Although three hinges 728 are depicted, fewer or more hinges 728 may be added as is known in the art. A locking mechanism 730 secures the door 726 shut against the body 712. Batteries powering the electrical circuit 300, 400, 500 may be housed in a battery compartment 732 contained in the door 726.

A recess 734 is provided on the rear 730 of the guitar body 712 to allow access to the headphone output and to manipulate buttons on the tablet computer 16, such as power, rotation lock, volume and mute switches.

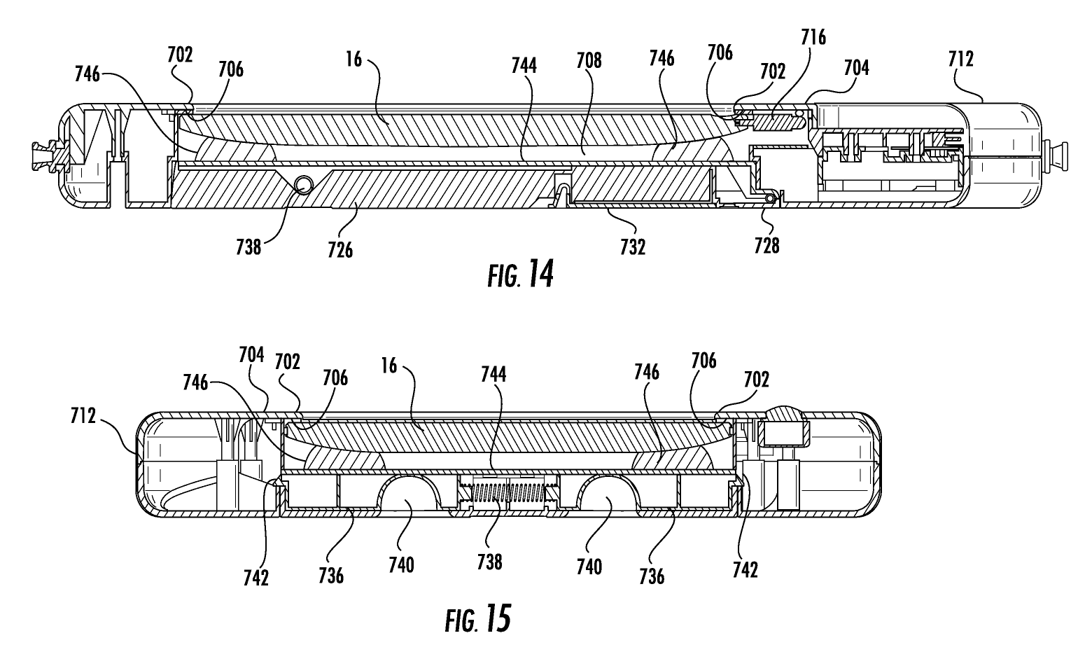

Referring to FIG. 14-15, the tablet computer 16 is recessed inside the body 712 of the guitar within the cavity 714, the lip 706 providing the musician tactile feedback when they have strayed off of the touch screen of the tablet computer 16. As shown, the tablet computer 16 is recessed 4.5 mm within the guitar body 712, but other depths may be used. Tablet computers 16 that are mounted within a guitar body 712 in a generally flush manner suffer the limitation that the musician may lose track of where they are on the tablet computer 16 touch screen.

The locking mechanism 730 includes a pair of locking members 736 biased outwardly from each other via a spring 738. The locking members 736 include finger holds 740, which a user squeezes together to release the locking mechanism 730 permitting the door 726 to be opened. Each locking member 736 includes a beveled tongue 742 that engages reliefs in the guitar body 712 to lock the door 726 shut.

The interior side 744 of the door 726 includes a compressable layer 746 that deforms to capture the tablet computer 16 against the lip 706 of the guitar body 712.

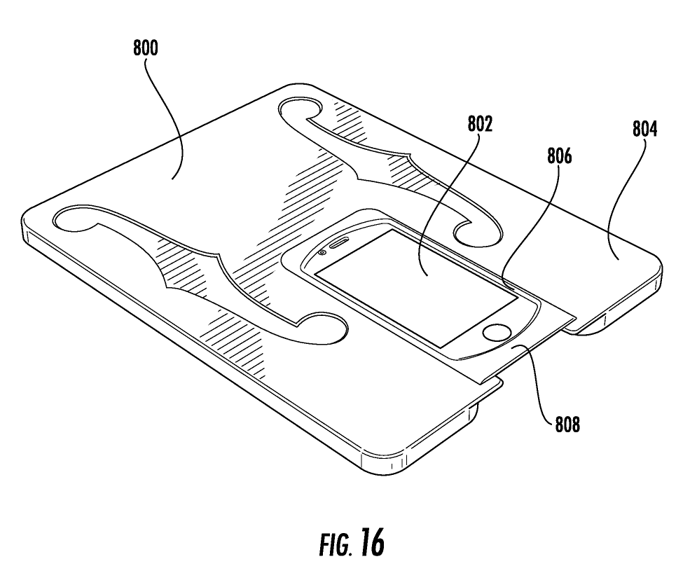

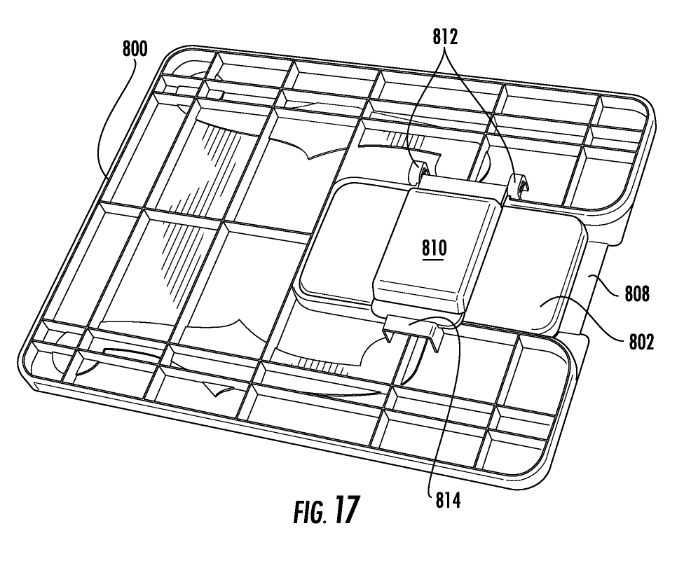

Referring now to FIGS. 16-17, an insert 800 is shown for adapting a smaller form factor of a tablet computer or a smaller smartphone or handheld computing device 802, such as an iPhone or iPod Touch brand handheld computing devices, into the controller 10, 100, 600, 700. The insert 800 is shaped like a tablet computer 16 and is sized and dimensioned to fit within the cavity 14, 114, 214, 714 of the body 12, 112, 212, 512, 612, 712 of the controller 10, 100, 200, 600, 700.

An adapter plate 808 is fitted to the top surface 804 of the insert 800. The adapter plate 808 includes a surface defining an aperture 806 through the adapter plate 808, which reveals the handheld computing device 802 when captured in the insert 800. Different adapter plates 808 may be used depending on the handheld computing device 802 that is desired to be used with the controller. Specifically, the shape and size of the aperture 806 is changed to accommodate different handheld computing devices 802.

A strap 810 hinged 812 to the bottom of the insert 800 at one end. The opposite end of the strap 810 engages a mating formation 814 on the insert 800 to secure the handheld computing device 802 within the insert 800.

In the most general sense, touching the touch surface of the tablet computer 16 triggers the sound while operating the controls 20, 104, 230, 306, 406, 502, 616 on the guitar neck 18, 102, 228, 614 determines the pitch of the sound or sounds, either by controlling individual notes or by determining whole chords with one press on the simulated fret positions. Either the tablet computer 16 or the controls 20, 104, 230, 306, 406, 502, 616 on the guitar neck 18, 102, 228, 614 may, in addition, affect the timbre of the sound, modulate the sound, or affect the sound in another way as is known in the art. Traditionally, a “whammy bar” is on the body of the guitar and would be used to bend the pitch of the sound. A whammy bar may be included on the controller 10, 100, 200, 300, 400, 500, 600, 700 to provide similar pitch-bending function as is known in the art.

It would be appreciated by those skilled in the art that various changes and modifications can be made to the illustrated embodiments without departing from the spirit of the present invention. All such modifications and changes are intended to be within the scope of the present invention.

What is claimed is:

1. A guitar controller, comprising:
a body having a cavity formed therein sized and dimensioned to receive a tablet computer therein, the body having an edge on a front of the body defining an opening into the cavity, the edge having a thickness forming a lip into the opening wherein the lip is configured and arranged to be received partially over the tablet computer;
a neck extending from the body having a plurality of simulated fret positions thereon; and
an electronic circuit electrically connected to the simulated fret positions and configured and arranged to transmit a message encoded with presses of the simulated fret positions to the tablet computer.

2. The guitar controller of claim 1, further comprising a door attached to a rear of the body, the door movable between an open position revealing a second opening into the cavity and a closed position blocking the second opening shut, the door further configured and arranged to compress the tablet computer against an interior portion of the lip when in the closed position.

3. The guitar controller of claim 2, wherein the door further comprises a compressable layer configured and arranged to press against the tablet computer.

4. The guitar controller of claim 2, further comprising a locking mechanism configured and arranged to lock the door in the closed position.

5. The guitar controller of claim 4, wherein the locking mechanism comprises at least one spring-biased member.

6. The guitar controller of claim 5, wherein the at least one spring-biased member slides within the door and into the body to lockably engage with the body when the door is in the closed position.

7. The guitar controller of claim 6, wherein the locking mechanism comprises two spring-biased members.

8. The guitar controller of claim 2, wherein the door includes a battery compartment configured and arranged to provide power to the microprocessor.

9. The guitar controller of claim 1, wherein the edge is partially interrupted at a portion of the opening into the cavity of the body defining a slot configured and arranged to slidably receive the tablet computer into the cavity.

10. The guitar controller of claim 9, wherein the slot is adjacent to the neck

11. The guitar controller of claim 9, wherein the slot is opposite the neck.

12. The guitar controller of claim 1, wherein the electronic circuit is configured and arranged to transmit messages to the tablet computer through a wired connection to the table computer.

13. The guitar controller of claim 12, wherein the messages are transmitted through a wired universal serial bus connection to the tablet computer.

14. The guitar controller of claim 1, wherein the electronic circuit is configured and arranged to transmit messages to the tablet computer through a wireless connection with the tablet computer

15. The guitar controller of claim 4, wherein the messages are wirelessly transmitted through Bluetooth wireless keyboard protocol.

16. The guitar controller of claim 1, wherein the electronic circuit is located in the neck of the guitar.

17. The guitar controller of claim 1, further comprising an insert sized and dimensioned to fit into the cavity and further configured and arranged to hold a handheld computing device securely within the cavity.

18. The guitar controller of claim 17, wherein the insert further comprises a strap hinged to the adapter and configured and arranged to lock the handheld computing device in facing arrangement with the adapter.

19. The guitar controller of claim 1, wherein the simulated fret positions are note buttons.

20. The guitar controller of claim 1, wherein the simulated fret positions are touch strip controllers.

21. The guitar controller of claim 1, wherein the simulated fret positions include lights, the lights selectably activatable and deactivatable by the electronic circuit.
